(19) United States
(12) Patent Application Publication
(10) Pub. No.: US 2016/0262476 A1
(43) Pub. Date: Sep. 15, 2016

(54) IMPROVEMENTS TO INTEGRATED PERSONAL MOBILE HANDSET STORAGE, ACCESS AND USE UNITS

(71) Applicant: FONEWEAR PTY LTD, Balwyn North (AU)

(72) Inventor: Peter CROCKETT, Balwyn North (AU)

(73) Assignee: FONEWEAR PTY LTD, Balwyn North, Victoria (AU)

(21) Appl. No.: 15/033,998

(22) PCT Filed: Nov. 5, 2014
(86) PCT No.: PCT/AU2014/001030

§ 371 Date: May 3, 2016

Related U.S. Application Data
(60) Provisional application No. 61/900,126, filed on Nov. 5, 2013.

(30) Foreign Application Priority Data
Feb. 21, 2014 (AU) 2014900573

(51) Int. Cl. A41D 27/20; H04M 1/05; G21F 1/10

(52) U.S. Cl. CPC A41D 27/205; G21F 1/10; H04M 1/05

(57) ABSTRACT

A garment has a stitched front pocket or holder for holding a mobile phone handset or a portable computing device. A concealed zipper is provided for fully enclosing and accessing the device. A top eyelet feed hole enables the use of handset earphones or headphones with a cable connection to the handset when the zip is closed. A resilient neoprene layer offers protection and handset holder reinforcement. The internal of the holder may be further divided into two compartments for storage of items such as credit cards and keys and accessed by cut slits. A standard pillowcase may also be provided with the holder at a top corner with neoprene flap hood closure.

### BACKGROUND OF THE INVENTION

Current handset holders include armbands, wrist bands, waist belts and waist belt pouches. These existing products are attachable and detachable accessories intended principally for temporary use only during certain activities of limited duration.

When an accessory is detached from the handset user, that user may put a handset—being a personal mobile electronic device such as a mobile phone, iPhone, iPod or mini-tablet—on a table, desk, bench or counter, or awkwardly in a bag or clothing pocket.

Current personal handset storage accessories do not offer persistent and integral handset storage, access and use.

Handset cases, handset wallets and carry bags containing a handset storage pocket or pockets are neither attachable accessories nor worn integrally with a garment. They are carried apart from the body, not as occasionally attached to the user. Within this category there is a sizeable and assorted number of handset wallets, cases—such as the sturdy Otterbox Armor Series and Defender Series, and Lifeproof range of handset cases—and handbags with internal pockets that may provide handset storage.

a) Temporarily Carried Accessories

The present retail range of detachable handset storage accessories, of which armbands and wristbands are generally secured by an adjustable strap, comprises:

i) Armbands: The following companies offer sports handset armbands for the upper arm: Fly, Wahoo, Belkin, icoustic, Tune Belt and Nike. In addition, Nike retails a handset sleeve for the forearm, while Speedo has produced an armband to enable a swimmer to listen to music from a waterproof encased MP3 player.

ii) Wristbands: The Griffin Sportcuff wristband is tailored to hold the Pod Nano 7th Generation 16 GB.

Waist belts: Waist belts fall into two categories, belts for travellers, such as those of the Monsac and Pacsafe brand names, and belts for sportspeople, which Fly, Midas, Nike and Karrimore offer.

iv) Waist belt pouches: The retail market presents a range of leather (including cowhide) and imitation leather waist belt clip-on pouches, varied in design and size, mainly with magnetic flap closure.

v) Neck wallet: A handset storage accessory may be suspended by cord and hung around the neck, witness the Goila GenMob Wallet, which is characterised by poor access.

b) Conventional Apparel Pockets

i) Pockets are generally open-topped, compromising security. Handsets fall out, and in many cases fall out easily, especially from breast pockets of garment tops as the consumer bends over. The problem of failed security is allied to the prospect of inflicted handset damage.

ii) Pockets are all-purpose storage ‘units’ of a haphazard range of sizes, fabrics and styles that are generally inappropriate in that they are not designed for perpetual, integrated, inconspicuous, durable and accessible handset wear.

iii) When the user is seated, handsets stored in pockets of trousers, shorts and skirts are often uncomfortable; they stick into the side or thigh. There is often a need to straighten the leg to allow sufficient room for the hand to enter the pocket to remove or store the handset.

iv) Pocket clutter and uncertain and inconsistent handset storage hinder ease and speed of handset access.

v) With storage of bulkier and heavier—and perhaps sharp or pointed—items, ordinary and generally unreinforced garment pockets form holes.

vi) Pockets are often used to hold keys, key rings and coins, which are made of metal, and a wide range of other small objects made, for instance, of metal or hard plastic, such as paper clips, other clips, staples (perhaps attached to receipts or other documents), screw tops (for example of nail polish, perfume or other cosmetics), pins, nails, screws, washers, plastic packaging with sharp corners and edges, any number of small hard-edged or pointed items. Handset screens can very easily be scratched by abrasive contact with such items, as well recognised by handset manufacturers; many handsets are sold with protective adhesive clear plastic screen film, which before long peels off. Consumers do not like scratched handset screens. Likewise, the exterior plastic cases of handsets can also be scratched when stored in general pockets.

vii) Whilst many handset users store their handsets in protective cases, of which there is a large variety, such cases share with handsets a need to be located—and in the example of cases to be opened—before the handset itself can be accessed. Additionally, handset cases muffle ringtone and vibration alerts, heightening the possibility of missing calls and messages.

viii) A large percentage of shirts, T-shirts and polo T-shirts and sports singlets (and certainly pullovers) are made without any pockets at all.

ix) If unlocked, handset phones stored in trouser pockets that press against hard objects or surfaces, especially furniture, may inadvertently activate, possibly at appreciable cost to the subscriber.

In relation to bedware—at present a consumer may keep a handset on a bedside table, with access hindered either by the need to stretch out an arm to fumble for access or by getting out of bed to take the handset in hand. Some handset users may store their handset under their pillow. If so, the handset may be misplaced or inadvertently knocked to the floor.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a mobile computing, device holder or pocket for integral attachment to an item of apparel comprising reinforcement to reduce sag and a means of reversibly attaching the mobile computing device now often called a ‘smartphone’ as well as a ‘handset’ within the holder.

According to another aspect of the invention, there is provided an item of apparel comprising an integral mobile computing device holder, the holder comprising reinforcement to reduce sag and a means of reversibly attaching the mobile computing device within the holder.

The holder of the invention is suitable for use with a wide range of mobile computing devices, including smart phones, computers, tablets, etc. The skilled addressee will appreciate that certain size limitations may limit the actual types of mobile computing devices used with the invention. However, in some embodiments, devices as large as 18 cm in length may be effectively used with the invention.

A useful aspect of the current invention is that the holder is integral within the item of apparel. This provides additional strength and utility and increases the aesthetic appeal of the holder.

The reinforcement may be of any suitable type. In some embodiments it comprises stitching, in others it may comprise the addition of specialised materials, such as rubber, metal (such as teel), cloths, fabrics, etc. In some embodiments neoprene may be used at least partially.

Some embodiments may further comprise an eyelet for passage of an earphone or a headphone cord or other useful connecting device (for example for an antenna, power plug, etc). In some embodiments the eyelet is reinforced which may for example be done with rubber.

Some embodiments of the invention comprise a garment for which the location of the holder of the invention has been designed to maximise ease of use by the wearer. Examples of such embodiments are chest location at the location where a hand would automatically reach for male garments and similarly hip locations for female garments. Some embodiments have the holder of the invention positioned close to the body which reduces movement of the holder and mobile computing device during movement. This effect may be added to by the reinforcement.

Some embodiments of the invention comprise other apparel, garments or bedware that a human would naturally closely interact with. For example in some embodiments, there is provided a pillowcase comprising a holder of the invention.

The means of reversibly attaching the mobile computing device within the holder may be of any suitable type. For example, it may comprise a zip, a press stud, a hood closure, a hook and loop fastener (such as Velcro®), a pull tag, a snap closure, and so on.

Some embodiments of the invention further comprise one or more additional holders in association with the holder of the invention. Such holders may for example be designed to hold everyday items such as keys, money, credit cards, etc.

In one aspect of the invention, there is provided a mobile computing device holder for integral attachment to an item of apparel comprising reinforcement to reduce sag and a reversible restraint for the mobile computing, device within the holder. In some embodiments, there is provided an item of apparel or an item of bedware comprising an integral mobile computing device holder as described herein.

The reinforcement may be of any suitable type. In some embodiments it comprises one or more of stitching or at least one structural material which is optionally one or more of rubber, metal, cloth, fabric, and neoprene. In some embodiments, the holder comprises an at least partially radioprotective material which optionally comprises one or more of neoprene, a silver-containing material, a bismuth-containing material, a lead-containing material, a barium containing material, a tungsten containing material, and kevlar. In one preferred embodiment, the holder comprises bismuth-impregnated neoprene which is optionally of thickness in the range 0.008 to 0.100 inches.

Neoprene reinforcement as a radioprotective material is precautionary only. The main purpose for using neoprene is that it is lightweight, machine washable, durable, sag resistant, waterproof, dustproof, snow proof and sweat resistant. As to the safety of personal handset use, the points at issue are:

1) It is use, not storage—whether on stand-by or turned off—that recommends that a handset be kept at 1.5 cm (% inch) or more away from the user's body to ensure that exposure levels remain at or below the maximum levels. Users may be expected overwhelmingly to store their handsets in Fonewear garments and pillowcases.

2) Longstanding and widespread use of handsets—currently there are approximately seven billion handsets in worldwide use—have not disclosed clear and proven publicly disseminated healthy problems ascribable to enduring handset properties and use.

3) Scientific studies have found no consistent link between handset use and cancers of the brain, central nervous system, or other tissues of the head or neck.

4) Radiofrequency energy is a form of electromagnetic radiation, specifically a form of non-ionizing radiation. There is no consistent evidence that non-ionizing radiation increases cancer risk. The only known biological effect of radiofrequency energy is heating. It is considered that rises in tissue or body temperature of about 1.0° C. or more are required before any adverse effect will occur. Exposure to the low level of RF radiation emitted from base station antennas will not cause any measurable, or noticeable, bodily temperature rise, negating any plausible health risk.

5) Electromagnetic compatibility (EMC) is achieved by limiting or controlling electromagnetic emissions. As electromagnetic transmitters the radiation characteristics of handsets (frequency, power etc.) are tightly regulated by standards set by organisations such as the European Telecommunications Standards Institute (ETSI). In fact future handset systems are being constructed with still less adverse EMC effects, with techniques for further reducing EMC effects to be implemented.

Nevertheless, in spite of the established and deepening safety of the storage and use of personal handsets, to reinforce the Fonewear radioprotective position through offering Fonewear handset holder construction fabrics that may be used as alternatives to neoprene fabric, the following options are herewith added:

1) The range of highly breathable electrospun fibre-based multifunctional protective fabrics using the layer-by-layer electrostatic assembly technique, a multifunctional protective fabric based on the reactive polyanion polyhydroxamic acid and the antimicrobial polycation poly (N-vinylguanidine) which benefits from the lightweight and high porosity of nanofibres and the incorporation of different functional polyelectrolytes.

2) Radioprotective materials which include barium, bismuth and tungsten. Such a material may be mixed with a powdered/pelletising polymer or a suitable liquid/emulsion. This mixture can then be combined with or layered upon another fabric such as Kevlar—a para-aramid synthetic fibre related to other aramids such as Nomex and Technora and spun into fabric sheets—to provide radioprotective capability.

3) A breathable lightweight fabric with radioprotective properties formed from its impregnation with a radiopaque compound, such as barium sulphate, acetrizoate sodium, iobenzamic, iopanoic acid or iopentol.

4) A superhydrophobic bifunction cotton fabric offering radioprotection that is treated with cerium oxide (CeO₂) solution and modified by a layer of dodecafluoroheptyl-propyl-trimethoxysilane (DFTMS).

5) The AttenuRad radioprotective range, products of which consist of a thin, flexible, bismuth (lead-free) fabric composition.

6) Fibertect, a dry contamination fabric that is commercially available in a range of forms and shapes with the capacity to adsorb toxic materials, that is, to hold molecules of a gas or liquid or solute to the fabric surface. The fabric consists of an absorbent top layer; an adsorbent highly porous middle layer such as an activated carbon, and a fibrous layer in the bottom to provide structural coherence and non-leaching capability. Fibertect allows the use of different types of fibres according to selected applications, such as polyester, raw cotton and bleached cotton.

7) Zorflex, manufactured as two products, is an activated carbon cloth with the capacity to decontaminate intricate objects without leaving dirty particles after decontamination.

In some embodiments, a holder according to the invention comprises an eyelet for passage of a wire or cord such as an earphone or a headphone cord or physical connection for another other useful connecting device. In embodiments comprising an article of apparel, certain preferred embodiments comprise at least one holder is integrally located on one or more of a hip, shoulder and breast.

The reversible restraint may be of any suitable type, and for example may comprise one or more of a zip, a press stud, a hood closure, a hook and loop fastener, a pull tag, an over welt, and a snap closure. In one embodiment, a holder of the invention comprises a fastener to reversibly fasten the restraint in a restraining position. The fastener may be of any suitable type, for example, it may comprise one or more of a zip, a press stud and f or Velcro.

There may also be provided as part of the invention a smaller holder to hold one or more additional items which may optionally be one or more of keys, money and credit cards.

In another aspect of the invention, there is provided a method of manufacturing an item of apparel or bedware comprising attaching a holder according to claim 1 to a pre-made article wherein the material defining an opening in the holder is at least attached around the perimeter of a corresponding opening in the item of apparel or bedware.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 depicts a front view of an example men's woven shirt according to the invention.

FIG. 2 depicts a rear view of an example men's woven shirt according to the invention.

FIG. 3 is a front view of an example handset holder according to the invention.

FIG. 4 is a side perspective view of an example handset holder according to the invention.

FIG. 5 depicts an example internal holder within a handset holder.

FIG. 6 is a front view of an example women's sports singlet according to the invention.

FIG. 7 is a rear view of an example women's sports singlet according to the invention.

FIG. 8 is a front view of an example handset holder according to the invention.

FIG. 9 is a side perspective view of an example handset holder according to the invention.

FIG. 10 is a front view of an example pillow case according to the invention.

FIG. 11 is a rear view of an example pillow case according to the invention.

FIG. 12 is a front view of an example handset holder according to the invention.

FIG. 13 is a side perspective view of an example handset holder according to the invention.

FIG. 14 depicts a side view of one embodiment of the invention comprising a press stud pull tag closure.

FIG. 15 depicts the embodiment of FIG. 14 with the closure in the closed position.

FIGS. 16 to 17 depict further details in respect of the socket and post elements of the press stud component of the closure of FIGS. 14 and 15.

### DETAILED DESCRIPTION OF EXEMPLARY EMBODIMENTS

It is convenient to describe the invention herein in relation to particularly preferred embodiments referred to herein as ‘Fonewear’ products. However, the invention is applicable to a wide range of situations and it is to be appreciated that other constructions and arrangements are also considered as falling within the scope of the invention. Various modifications, alterations, variations and or additions to the construction and arrangements described herein are also considered as falling within the ambit and scope of the present invention.

Mobile handsets of a vast number and range, with a multiplicity of applications, have attained an advanced technological state. Yet all available handset accessories that provide personal handset storage and accessibility are lacking, with handsets either positioned away from the user, carried inconstantly in bags and cases, or attached to the body for a time of limited availability, notably during sporting activity.

Fonewear apparel and pillowcases offer affixed purpose-built mobile handset holders that provide uninterrupted handset proximity to the user, indoors and outdoors, at work and away from work, day and night.

The Fonewear handset holder may be made from any suitable material. In some embodiments, it comprises a durable, reinforced, sag-resistant design. In some embodiments it comprises neoprene. Certain embodiments comprise for example handset cable eyelet feed and with secure, handset accessible, intimate personal spatiality providing prompt handset reaction time. The holder portions according to the invention are of sufficiently large size comfortably to accommodate all but the very largest of handsets. Integrated to garment and to pillowcase, the assimilated products are unobtrusive.

In some embodiments of the invention, there is provided an item of apparel with an integral holder for a mobile communication device. Through day-long wear, and given the effectiveness of its features, such embodiments of the invention afford fluent, secure and lasting mobile handset storage, access and use.

In some embodiments, there is provided an item of bedwear with an integral holder for a mobile communication device. Through night-long proximity and given the effectiveness of its combined features, such embodiments afford fluent, convenient and lasting mobile handset storage, access and use through which handset holder position options may comprise any position at or towards edges and corners of standard, king and European styled pillowcases, or any other pillowcase style such as those for curved, travel or children's pillows.

Through the combined function of such embodiments, a twofold dynamism of continuous, closely stored, accessible and fluidly usable mobile handset management may be attained. First, the handset holder affixed to apparel affords day-long handset storage, access and use of a worn handset. Second, with complementary night-long handset storage and access, day and night storage, access and use combine to provide continuous, secure and easy storage, access and use.

In some embodiments, there is provided a functional, well-designed and attractive apparel garment that has affixed a holder or holders designed for the secure storage and fluent access of handsets which commonly provide to the user through ranges of electronic applications portable communication, information and entertainment facilities.

The handset may be secured within the holder according to the invention by any suitable means. In some embodiments, the Fonewear holder may be secured by zip closure or other closure such as hood or stud closure, be manufactured with natural or synthetic material—although neoprene is used in some preferred embodiments—and be positioned on the garment at the upper arm, shoulder, breast, hip or waist.

The Fonewear garment may be constructed with natural and/or synthetic material, and garment ranges may be in a variety of sizes, designs, patterns and colours in clothing ranges for men, women and children in the clothing classes of casual wear, sportswear, work wear, business wear, formal wear, swim wear and any other class of clothing production. Initially the manufacture of garment tops—shirts and singlets—in casual, sports and work wear are to be preferred.

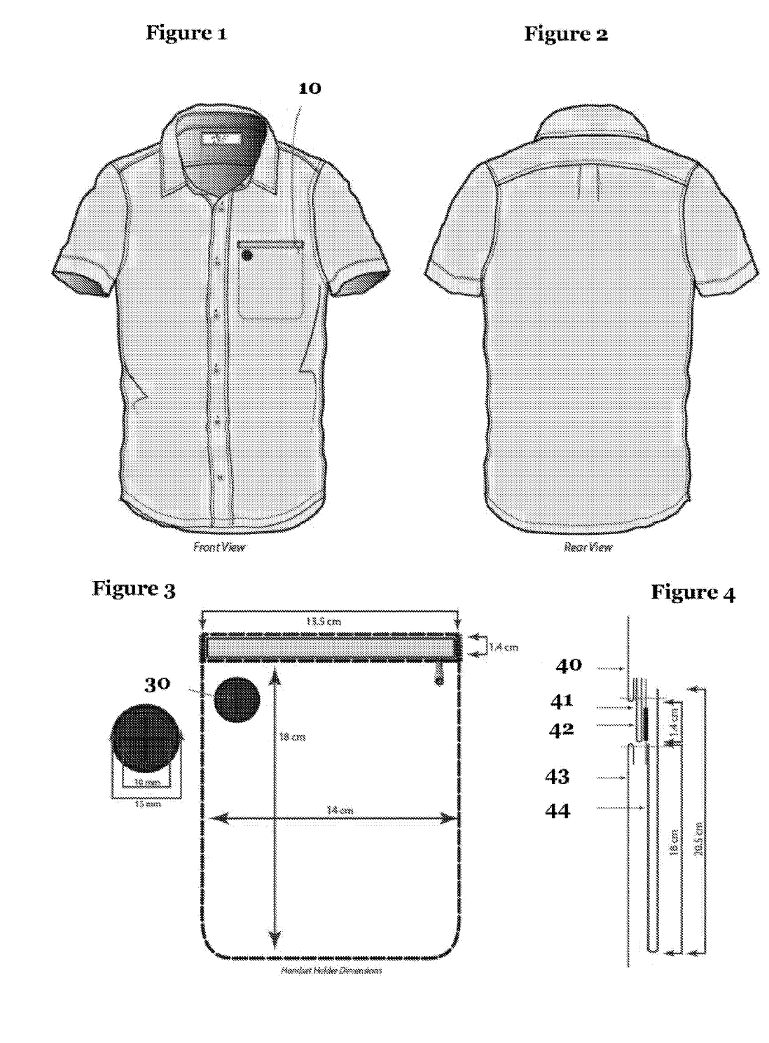

FIGS. 1 to 4 depict a short sleeved men's woven shirt to be of 100% cotton 40s poplin, showing front and rear view, with chest positioned full neoprene handset holder in front and side perspective affixed internally to the garment by stitching, with cable eyelet feed hole and over welt with concealed zip and press stud closure according to the present invention. FIG. 1 depicts a welt handset holder (10) with zip press stud closure, FIG. 3 depicts a rubber sew-on cable eyelet feed hole (30). FIG. 4 depicts a side view of the design of the various layers of a holder according to the invention. Outer garment (40) sits in front of over welt (41) which sits over concealed zip (42). On the lower side, outer garment (43) sits outside the 1 mm think neoprene layer (44) of the holder.

The Fonewear Men's Sports T-shirt garment comprises a handset holder with concealed Zip with Zip Pull affixed to the garment by styled stitching displaying unobtrusive integrated design and in this embodiment is optionally positioned at the breast for easy daytime access providing prompt response time. The garment has a fully enclosed ready access handset holder of neoprene fabric of spacious 18 cm×14 cm dimensions sufficiently large to accommodate all but the largest of handsets. The zip width at 13.5 cm is sufficiently wide to allow entry of all but the largest of handsets, The zip itself in some embodiments with Pull Tag Stud Snap Closure provides sound security and prevents the handset from inadvertently falling out. A top cable eyelet feed hole lower cases enables use of handset earphone or headphone with cable connection to handset with zip closed. In side perspective the holder is positioned internally within the garment for close fit and an unobtrusiveness and security that are aided by concealment of the zip. Resilient neoprene offers protection and handset holder reinforcement. In sports garment embodiments, within and stitched to the back of the handset holder, is located a 10 cm long and 12 cm wide internal holder, the top of which is positioned behind the zip, and is shown in this inner position in side perspective. The internal holder is divided into two compartments, one for storage of credit card etc., the other for storage of key etc., each accessed by cut slits, with dimensions provided. The internal holder is made of strong protective neoprene.

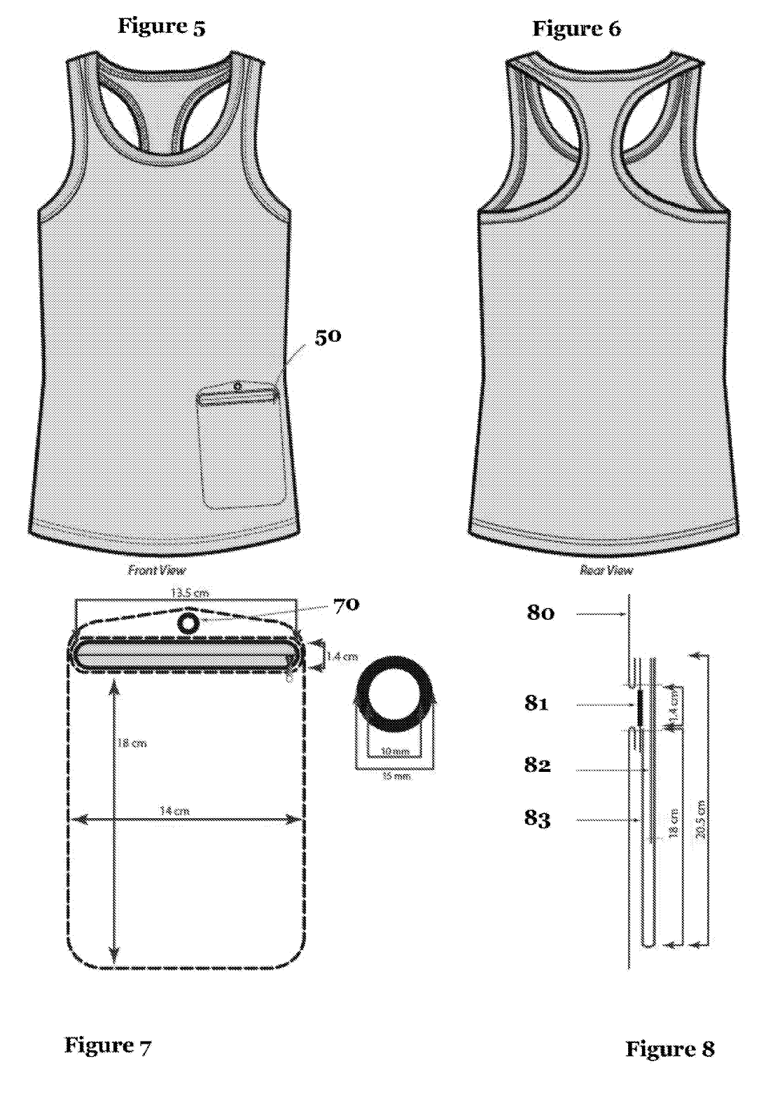

FIGS. 5 to 8 depict a women's racer back sports singlet to be of cotton and polyester sports fabric showing front and rear view, with full neoprene handset holder and internal bag for key, credit card etc.—positioned at the left hip—in front and side perspective affixed internally to the garment by stitching, with cable eyelet feed hole and concealed zip with pull closure according to the present invention. FIG. 5 depicts a concealed zip with zip pull (50). FIG. 7 depicts a plastisol printed cable eyelet feed hole (70), FIG. 8 depicts a side view of a holder according to FIG. 7 with outer garment (80) a concealed zip (81), 1 mm thick neoprene internal holder (82) (for example keys or a credit card etc) and a 1 mm think neoprene holder (83).

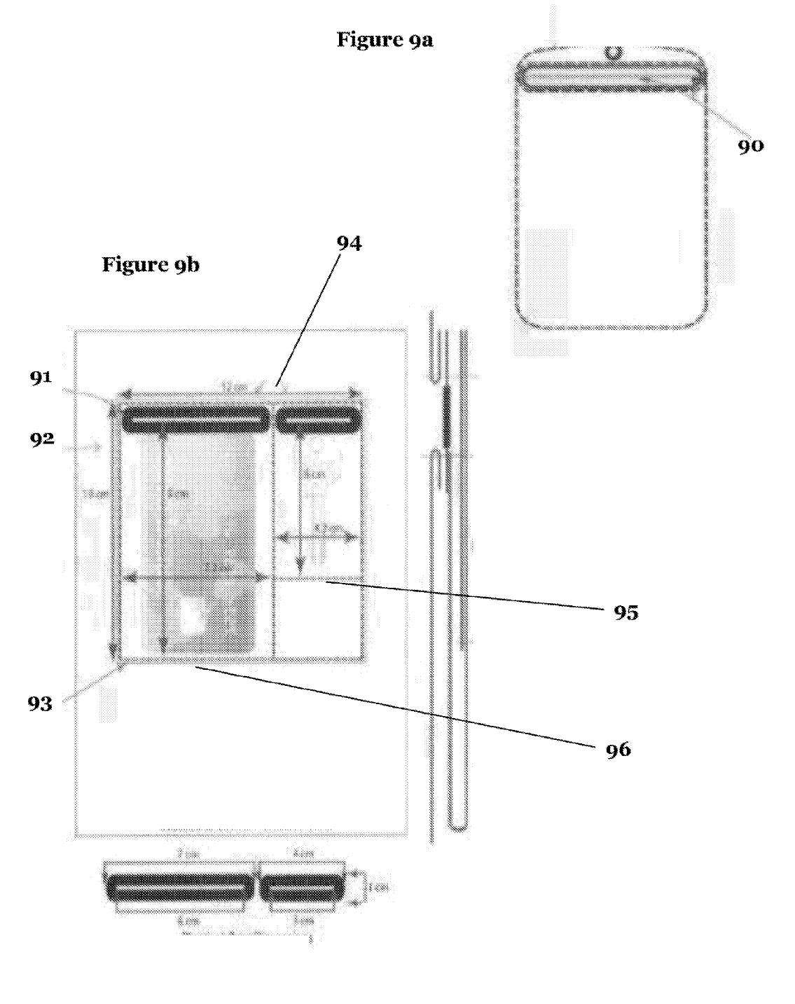

FIGS. 9a and 9b depict in front and side perspective a holder affixed internally to the garment by stitching, with cable eyelet feed hole and concealed zip with zip pull closure according to the invention. FIG. 9a depicts an internal holder (90) for a key or credit etc behind a zip. FIG. 9b depicts a plastisol printed reinforcement (91) for cut slits in the neoprene, an internal holder (92), and 1 mm think neoprene stitched on top for internal holder (93). The internal holder is divided into two compartments, one for storage of credit card etc. (96), the other for storage of key etc. (95), each accessed by cut slits (94).

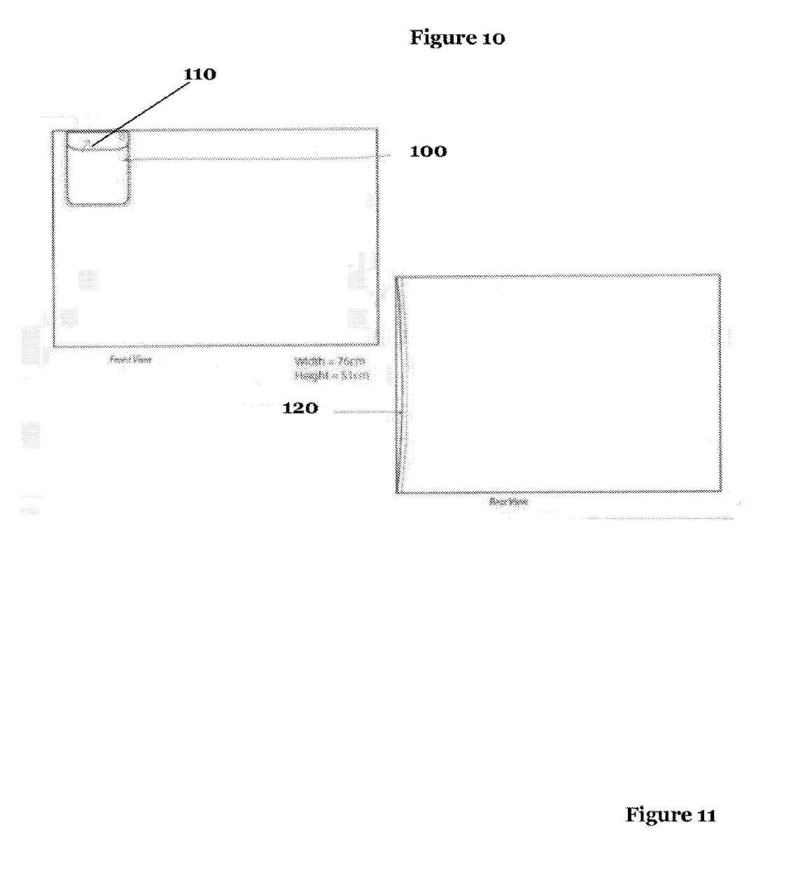

FIGS. 10 to 11 depict a standard pillowcase to be of cotton sheeting showing the pillowcase opening and full neoprene handset holder—with handset holder opening positioned towards the edge of the pillowcase—affixed by internal stitching towards the top left pillowcase, with cable eyelet feed hole according to the present invention.

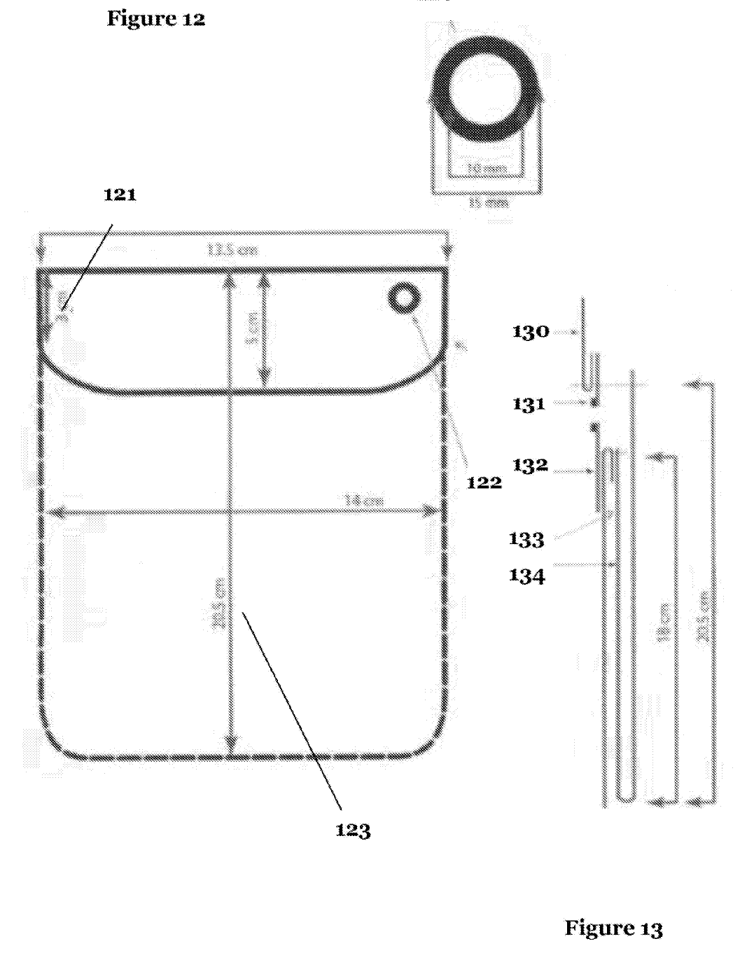

FIGS. 12 and 13 depict the pillowcases' full neoprene handset holder in front and side perspective to be constructed internally within all pillowcases and of generous 20.5 cm length, with top 3 cm of the opening stitched to the handset holder to assure handset retention and with an easy access flap opening according to the present invention.

In this embodiment the standard pillowcase has a top corner handset holder (100) with smooth neoprene flap hood opening (110), with prompt and assured handset accessibility afforded by close and continuous night-time proximity to the user. The top of the handset holder (100) is positioned away from the user's reclining head and is stitched at the edge of the pillowcase to prevent any possibility of inadvertent interference with the handset user. For added ease of storage and access, the full handset holder length of 20.5 cm is provided (123), with the top 3 cm of the hood closure (121) stitched to the holder to ensure that the handset sits securely within the holder. A Cable Eyelet Feed Hole (122) allows cable connection. By its positioning inside the pillowcase the handset holder enjoys an unobtrusive stylistic integration with the pillowcase (133). Outer pillow case (130) sits over the plastisiol printed cable eyelet feed hole (131) which is adjacent the top holder flap (132) (1 mm neoprene) and over the 1 mm neoprene holder (134).

For male styling the handset holder may be positioned at the left or right breast of a garment shirt or singlet to aid efficient handset storage, access and use. A breast positioned holder is to be placed close to the body, sitting inside the garment, and with an easy movement of the arm, handset access will be fluid. For female styling the handset holder may be positioned at the left or right hip of the garment shirt or singlet. For aesthetic and comfort purposes the hip position is to be preferred since it is discreetly distanced from the protruding breast, with handset access fluently enabled by a single and simple arm movement. Given the size and lower placement of the holder, a holder positioned at the side or hip will necessitate the wearing of a shirt or singlet over trousers, shorts or skirt, that is, not tucked into the waist of a lower garment. Given that the female handset holder is situated inside the top, is integral to the garment, and overall has an unobtrusive look and feel, the handset positioned at the hip will have a snug fit—under normal circumstances it will not make inadvertent contact with nearby objects. By garment design and manufacture the female handset holder is to sit quite dose to the body, having minimal free incidental movement.

In some preferred embodiments, the purpose-designed handset holder has a height of 18.0 cm and a width of 14.0 cm and be in the ranges of 10 to 24 cm in height and 4 to 20 cm in width—dimensions that may alter according to market conditions—is to be unobtrusive, of attractive styling, subtly reinforced and durable, and designed specifically for fast, effortless access.

In some embodiments, additional security may be attained for example with additional fasteners such as a top holder auto-lock zip or zip with press stud closure. Handset holder spaciousness, simplicity and incorporation in the garment are important in some embodiments. The handset holder in casual wear, work wear and sportswear will accommodate all but the largest handset. Even the more modern, mini tablets may be carried in some embodiments.

Neoprene is used in some preferred embodiments as the preferred material for Fonewear handset holder construction, and is drawn from a family of synthetic rubbers, has better natural weathering resistance than natural rubber and moderate resistance to oil, heat, cold and ozone fluids. Neoprene maintains flexibility and softness over a wide temperature range, and is noted for chemical resistance and overall durability, providing long product lifespan.

Neoprene has a noticeable protective attribute, as it lessens the impact of contact with hard objects and surfaces, and is waterproof: it is used for wetsuits, fly fishing waders and automotive seat covers. Neoprene is waterproof because molecules are too big to pass through gaps in between polymer strands. Also, with neoprene there is no hydrogen bonding within the water when it is spread over neoprene, and neoprene itself contains no hydrogen from water with which to bond to that applied water. Neoprene also enjoys an appealing look and feel and is favoured by many makers, is lightweight, machine washable, dustproof, snow proof and sweat resistant.

Since the Fonewear handset holder is affixed to the apparel garment, the handset may be worn for as long as the garment is worn. Thus the handset holder offers enduring, convenient and immediate ‘one-touch’ handset access.

### Other Handset Holder Characteristics

i) Sag Resistant

In some embodiments, the design incorporates neoprene of sufficient thickness—further strengthened and stabilised by holder stitched attachment to garment—resiliently to prevent handset holder sag, noting the size, bulk and slightly heavier weight of larger handsets.

ii) Second Garment Top Handset Holder

In some embodiments, the design may incorporate a second left or right breast handset holder, or hip holder (towards the front, above the waist), to enable storage of a second handset, perhaps a cordless telephone, or assorted items.

iii) Secure

In some embodiments, the handset holder may to be secured by a zip with pull tag stud snap, auto-lock or any other closure. For stability, reliability and durability, the zip may be made wholly of hard plastic, not metal.

iv) Easy Access

In some embodiments, the handset holder may feature an easy open zip or press stud for fast handset access.

v) Accommodates Most Large Handsets

In some embodiments, the handset holder design efficiently fits the vast majority of handset sizes, including most taller models (and in some cases will comfortably accommodate handsets housed in their handset cases).

vi) Handset Holder Spaciousness

In some embodiments, such is the spaciousness of the handset holder, earphone or headphone cables may be stored with the handset within the handset holder. In some instances earphones may additionally be stored in the holder with cable and handset. In some instances, furthermore, charge pack and its cable may be stored in the holder with handset.

vii) Unobtrusive Design

In some embodiments, by design the handset holder is to be located inside the Fonewear garment, minimising handset protrusion, while overall garment and holder production integration shall provide inconspicuous handset and holder look and feel.

viii) Handset Cable Eyelet Feed

In some embodiments, a dedicated handset cable eyelet feed feature will efficiently enable the user to wear an earphone or headphone with the cable connected to the handset.

ix) Additional Internal Holder

In some embodiments, in sportswear the design incorporates an additional Fonewear holder within the handset holder for storage of house key, credit card, cash etc.

x) Prompt Response Time

In some embodiments, standard use of the spatially close holder affords effective control to assure smooth handset access and handling, thus minimising any possibility of mishap.

xi) Enhanced Convenience

In some embodiments, through constant handset storage and access, a flexible use of handset applications is offered by the handset holder's uninterrupted convenience.

xii) Health and Safety

In some embodiments, Neoprene is used for health and safety reasons due to its radioprotective attributes. Some embodiments may comprise bismuth-impregnated neoprene of thickness in the range 0.008 to 0.100 inches, and in some embodiments of 0.008 inch thickness. Scientific studies, and the longstanding and widespread use of personal handsets—currently there are approximately seven billion handsets in worldwide use have not disclosed clear and proven publicly disseminated health problems ascribable to enduring handset properties and use.

xiii) Comfort

Fonewear maker and garment size details are to be printed into the fabric of the neck of the garment, not to be provided within a separate sewn fabric label, thereby preventing irritation caused by a fabric label rubbing the back of the neck.

xiv) Warranty

One year limited back to base warranty to be displayed on product packaging.

xv) Patent and Trademark

Brief, basic patent and trademark registration details to be rendered in a fold-in label sewn into the inner body of the garment.

In some embodiments, there is provided a bedware item comprising an integral holder according to the invention. According to such aspects of the invention, there is provided a functional, well-designed and attractive bed linen feature that has affixed a holder or holders designed for the secure storage and fluent access of such personal mobile electronic handsets as mobile phones, iPods and iPhones etc, which commonly offer communication, information and entertainment facilities.

The bedware may be constructed of any suitable materials. For example a Fonewear pillowcase may be constructed of natural and/or synthetic material, and the pillowcase range may include a variety of sizes, designs, patterns and colours in mainly but not exclusively standard, king and European pillow style and configuration. Initially the manufacture of Fonewear pillowcases for standard-sized pillows are preferred in some embodiments.

In some embodiments, there is provided an item of apparel comprising an integral holder according to the invention. The multi-featured Fonewear handset holder is integrated by manufactured stitching (or any other form of manufactured attachment) into the design and construction of the Fonewear garment. That integration offers the consumer the capacity comfortably to ‘wear’ a personal handset just as the consumer ‘wears’ a garment.

A feature of some embodiments of the Fonewear casual wear garment is the assimilation of the distinctive high-profile—because multi-featured—handset holder to the low-profile garment, of subdued patterns, colours and styles. (Colourations and designs of Fonewear sportswear garments may however be of a higher profile.)

Fonewear apparel features together constitute substantial usefulness; apparel affixed to a handset holder that is sag resistant, secure, handset accessible, capacious, unobtrusive and bears cable eyelet feed, acting in combination to allow prompt response and access, continuous day and night proximity, thus reducing mishandling and misplacement. Further, since the consumer now seeks a bigger handset viewing screen, taller handset models are currently marketed in large numbers. This development makes the 18.0 cm. Fonewear handset holder length a unique, ground-breaking idea and design. Yet compactness of design continues to be a key feature of most handsets, making portability in the Fonewear holder convenient and comfortable.

A Fonewear garment is intended to house a handset virtually for the duration of any given day. With Fonewear apparel this would be comfortable since handsets are generally slim, compact and lightweight, and the Fonewear holder design is efficient in handset storage and access, snug in wear and unobtrusive in look, and feel. Through constant portability a handset is designed for day-long garment wear regardless of circumstance, the handset being intended for wear when the user was outdoors, moving between indoors and outdoors, or intermittently moving about indoors. Consumers who wear casual, sports and work clothing tend to spend much time outdoors in shirts and T-shirts. Fonewear garment portability and accessibility are novel in that they enable proper handset utilisation since the handset moves securely with the consumer as it is stored within the consumer's clothing.

The depth of usefulness is further expressed by the redundancy of constant decision-making: the handset user does not decide or remember to carry the handset when moving because as a matter of course the user is wearing that handset.

Design and manufacturing innovation induces attitudinal and realised usefulness since, in effect, the mobile handset and mobile self become united as a single techno-human unit. Ever-present ‘one-touch’ handset access and use are provided by that unity. With the Fonewear apparel design, the user can touch at will the portable technological device, an always timely, tactile ‘touch-tech’. Perpetual easy wear, access and use and an interlocking of individual with personal technology encapsulate the usefulness, in function and style, of Fonewear innovation. Through prompt touch, Fonewear gratifies psyche within a personal space which ‘coheres’ to body through the medium of a portable technological device.

In its features of day-long wear and the unobtrusive assimilation of reinforced handset holder design into garment design and illustration, the Fonewear garment is qualitatively and functionally distinct from personal handset storage products that are currently available such as armbands, wrist bands, waist belts and waist belt pouches. For these existing products are attachable and detachable accessories intended principally for temporary use only during certain activities of limited duration. Since they are personal handset storage products, collectively they form the prior art base. When an accessory is detached from the handset user, that user may put a handset on a table, desk, bench or counter, or awkwardly in a bag or clothing pocket.

Current popularly marketed clothing does not contain purpose-designed handset holders for easy handset positioning and access, whether at the left or right thigh, hip, waist, breast, shoulder or upper arm or any combination of these. The handset user does not ‘wear’ the handset, which undermines the very mobility of a ‘mobile’ handset—the handset loses contact with the user, it becomes immobile. The benefit of routine consistent wear, as a garment with handset is consistently worn throughout the day, is therefore lost with these accessories, an inconvenience of sporadic use that is quite different from the Fonewear proposal. When a handset user is moving about, portability is only truly attained when use is provided through a perpetually worn touch-access that assures uninterrupted dependable handset handling.

Certain embodiments comprise the following important Fonewear distinctions:

1) Creators of current garments are primarily concerned to produce a fashion or work wear garment. Should a handset pocket be an affixed part of the garment, this pocket has been shown to be a secondary and superficial consideration, lacking in closely designed and constructed attributes. In the case of Fonewear products, the unexampled multi-featured purpose designed and constructed handset holder is the primary consideration, with the holder's integration into an attractive high quality garment and pillowcase a resultant consideration.

2) In some cases it may be noticed that a work jacket, a work vest or sportswear T-shirt of singlet includes an affixed handset pocket. These garments are demonstrably inadequate for denying handset management to the consumer through the removal of such a garment, as would be expected with, for example, the consumer going indoors to a warmer environment or finishing the activity for which the garment was worn. The loss of continual handset management, a crucial shackling failing, is to he sharply contrasted with Fonewear's emancipating handset management, ceaseless, day and night, 365 days a year.

3) Not only do Fonewear products offer continual handset management, they offer a full range of men's, women's and children's casual wear and sportswear, which is a marked difference from the limited ranges of garments which offer only a limited measure of handset management facility.

4) Through product design and production, through product range and handset holder feature depth, and through consequent marketing strategy online and offline breadth, the function and apparel—bedware cross-disciplinary distinction between Fonewear products and such products is a palpable distinction of personal handset management type, quality and definition that is so pronounced as to demonstrate ground-breaking invention. Superior consumer empowerment resulting from that novelty is expressed through a level of handset management fluency and control whose unprecedented effectiveness is demonstrated by continuous spatially immediate access to an array of handset applications.

The multi-featured Fonewear handset holder is integrated by manufactured stitching or any other form of manufactured attachment) into the design and construction of the Fonewear pillowcase. That integration offers the consumer convenient proximity due to the specific night-long adaptation of handset storage, ready handset access and use in the form of the Fonewear pillowcase.

Fonewear pillowcase features together constitute substantial usefulness: stitched to the pillowcase is a handset holder that is sag resistant, secure, handset accessible, capacious, unobtrusive and bears cable eyelet feed, acting in combination to provide prompt handset reaction time, continuous night-time proximity, reducing mishandling and misplacement. Further, since the consumer now seeks a bigger handset viewing screen, taller handset models are currently marketed in large numbers. This development makes the 20.5 cm Fonewear handset holder length a unique, ground-breaking idea and design.

A Fonewear pillowcase allows storage of a handset in close proximity to the user virtually for the duration of any given night. With a Fonewear pillowcase this would also be comfortable since handsets are generally slim, compact and lightweight, and the Fonewear holder design is efficient in handset storage and access and unobtrusive in look and feel. As with the Fonewear garment holder, the design and manufacturing innovation of the pillowcase holder also induces attitudinal change and realised usefulness since, in effect, the mobile handset and mobile self become united as a single techno-human unit. Ever-present ‘one-touch’ handset access and use is provided by that unity. With close proximity the user can touch at will the portable technological device. Perpetual easy wear, access and use and an interlocking of individual with personal technology encapsulate the usefulness, in function and style, of Fonewear innovation. Through prompt touch, Fonewear gratifies psyche within a personal space which ‘coheres’ to body through the medium of a portable technological device.

The Fonewear pillowcase allows fluent access by hood closure to a handset, with ready touch-access use, with no need for bedroom lighting. Once more the spatial arguments of immediacy and somatic and psychological complementarity with proximity apply.

Through daytime handset garment wear and through night-time handset pillowcase accessibility, Fonewear offers continuous handset proximity, affording convenient and ongoing handset storage, access and use.

At present a consumer may keep a handset on a bedside table, with access hindered either by the need to stretch out an arm to fumble for access or by getting out of bed to take the handset in hand. Some handset users may store their handset under their pillow. If so, this method is highly fallible—the handset may be misplaced or inadvertently knocked to the floor.

The discipline of human factors applies for human use scientific information about objects, systems and the environment. Notably, Fonewear uses biomechanics—in this case the study of the mechanical laws relating to the movement of the human body—to structure and position the handset holder, contoured to the male and the female form, for the most convenient and fluent handset storage, access and use. The focus on human factors in the portable handset, as it relates to management of the handset as an applied system is apparent in the purposed-designed handset holder features.

Engineering psychology, the science of human behaviour and capability, and applied to the design and operation of systems and technology, relates to the Fonewear inventions in that these cater for psychological needs to have a handset at close quarters, on prompt stand-by, over extensive periods of time. To the extent that engineering psychology seeks to make the relationship between humans and technology more ‘user friendly’, the Fonewear inventions do this: they adapt sophisticated handset equipment to people and their immediate spatial environment by comfortable, convenient, fluent, prompt interconnection. The matching of product requirements to human desires and attributes is, for example, evident in the innovative concept and design of the Fonewear personal handset storage, access and use, which forms a system design of heightened convenience and open-ended duration. It optimises the effectiveness with which this facet of human activity is conducted and improves the general quality of life through reduced stress and increased comfort and satisfaction. For instance the routinely smoother and faster handling of the handset is a particular feature of the Fonewear inventions that will appeal to consumers.

If human factors, in essence, concern the study of designing equipment and devices that suit the human body and its cognitive abilities, an important feature of Fonewear inventions lies in designing apparel and bedware that presents a fluent correspondence between the human body and its cognitive abilities on one hand and the storage, access and use of portable handset devices on the other. The Fonewear inventions are useful in constituting an unbroken connection between a handset and efficient personal handset management expressed as perpetual readiness. Fonewear creates a fresh interdisciplinary perspective concerned with the understanding and accommodation of interactions between a human and a handset within the contours and dimensions of the human body, in order to optimise human well-being through overall system performance offered by correlation between the Fonewear invention and a handset. If in this disciplinary sense Fonewear represents a new conception of the human—computer relationship, it is within the multidisciplinary embrace of industrial, graphic and fashion design, general, commercial and media psychology, and biomechanics that Fonewear expresses this new conception.

In the sense that Fonewear is concerned with the aesthetic and functional disposition of and correspondence between handset user, portable handset equipment and the immediate spatial environment, Fonewear engages the work- and non-work-related spheres of human factors through the product correlation of consumer and handset management system analysis. Expressed in another way, the ‘creeping featurism’ of complex hand-held devices is systematically adapted by Fonewear to perpetual day and night handset management through the storage, access and use of such devices. For Fonewear brings into conjunction in enduring immediacy an individual's fluent movements, storage and access demands of the handset user and the physical dimensions of handset ranges.

Of human factors' subjects pertinent to Fonewear, namely usability, design adaptability to user experience and human-computer interaction, it is human-computer interaction (HCl) that notably warrants discussion, Human-computer interaction—the study, planning and design of the interaction between humans and computers—considers the many avenues of computer use through unconstrained user and computer reciprocity. The Fonewear inventions enhance the fluid conjunction between user and computer by making handsets more usable, more responsive to user need, by employing the constant facility of handset storage, access and use to correlate myriad computer applications to the human desire for computer-use satisfaction, the facility of constant handset immediacy aiding personal communication, information and entertainment management outdoors and indoors, and in daytime and night-time, environments. The Fonewear inventions thereby create a new domain for applying and developing design and psychological theory in the context of personal and compact technology accommodation and use.

Given that the sphere of theoretical and applied action of HCl involves the layperson's conception of computer and information technology and its personal impact, Fonewear opens a new, more textured cultural aspect of HCl by providing an efficiency substantively greater than that offered by handset storage accessories. For Fonewear enhances the human practice of seeking interrelation with compact technological devices; employs that interrelation to communicate with other humans; and enables the fluent indulgence of these interrelations at any time of the day or night. The cultural, communication, commercial and psychological facets of Fonewear link the knowledge sphere of Fonewear to the discipline of social science. For instance, the mass-media applications of handsets are a central field of enquiry of communication studies. Fonewear provides full and continuing opportunity for communication by personal handset use.

Inasmuch as HCl is a science of design, it is in a spatially immediate context that Fonewear employs industrial graphic and fashion design—and through prototyping explores new possibilities in handset holder design and placement—to apprehend and enhance the experience of human-computer interaction. By the pragmatic interconnection of human requirements with mobile devices. Fonewear enlivens the profile of applied psychology as a design science. For Fonewear design has been enriched by field study to ascertain handset users' requirements and circumstances; by shop floor enquiry at garment, bedware and handset outlets; and through quantitative and qualitative market research, which, tied into studio and computer design work, has resulted in a conceptually and commercially rounded Fonewear HCl innovation.

The usefulness of each Fonewear invention can be seen in the demands of applied practical wear, or dependable touch access availability, conceived from an understanding of culture; behaviourism; industrial, graphic and fashion design; general, commercial and media psychology; and biomechanics. Within this understanding Fonewear is responsive to features of the environment, the role of the portable technology artefact, motivations, and the complexity of real-life activity. Conceptual and design innovation occurs through a full recasting of the notion of continuous touch proximity to a handset—continuous storage and access denotes cultural transition, not least through recognition of a growing social complexity that creates in consumers a robust motivation for ready handset reaction. The Fonewear inventions articulate a bridging of the gap between the individual's present intermittent, disrupted handset arrangement and a striking immediate visual and tactile environment—evident in the interactive handset look, feel and compactness—of social communication, information and entertainment. Immediate and production-integrated proximity of handset holder to user denotes environmental transition through the fluent facility offered by each Fonewear invention mediating between the individual handset-management demands and that environment. Just as that mediation shows the Fonewear concept as being a handset-oriented techno-human activity system, the full circular causal relationship created by continuous handset storage, access and use forms a cultural redetermination of the capacity or scope of personal habit through a qualitative leap of secure, unobtrusive, fluent and prompt handset management from current ranges of handset classes. This system is also marked by individual connection to community circumscribed by handset applications' storage, access and use through continuous touch access affording enduring social communication. A community member, the handset user is moreover engaged in a social activity inasmuch as both the concepts of Fonewear products and the forms of handset applications may be shared. The Fonewear system is to be influenced by consumer preferences, which in turn govern Fonewear design and application decisions, and that system is to be regulated by conventions, guidelines and rules that shape handset production.

The usefulness of the Fonewear inventions is perceived in the tensions resolved by an ever-present storage, access and utility handset facility. This has been created in response to the mechanical attributes and limitations of the quiescent and dynamic human body; the management capabilities and potential mishaps associated with mobile devices: the 24-hour cycle of work, recreation and sleep; and the design of convenient access to a handset for the clothed and the reclining user.

Fonewear products offer continuous availability of a purposeful interaction between the human agent and the mobile device—facility of communication, information and entertainment. The user is internally engaged in handset activity by a psychological process in interaction with the objective reality of handset and Fonewear holder affixed to apparel and pillowcase. Such palpable objects possess and express cultural and social qualities of human interaction through the engagement of the individual with compactly presented technology and with such ease of access as to be symbiotic: the interaction is attained through close retention of the handset, which largely structures that interaction. Notably, the changing physical dimensions of ranges of handsets prompt a need for mediation between user and handset. The tailoring of Fonewear products—witness the 18.0 cm height of the garment handset holder—is designed to meet this need.

The Fonewear usefulness of storage, access and continuous availability of the device coalesces electronic object with a human internal process that is generally manifested in cognitive activity. In these senses the Fonewear inventions form cleaner, more encompassing, interactions than those provided by currently available handset storage accessories.

Activity theory is important to the construction and operation of the Fonewear inventions. Within this theory an activity may be interpreted as a human system in which an outcome is sought from performing tasks distinguishable according to their objectives. Consumer employment of Fonewear apparel and bedware products is a pragmatic activity created through a systemic interaction of handset with handset holder that liberates, indeed empowers, the consumer through the performed objectives of constant handset wear and superior storage, access and use facility.

We currently have a strange inconsistency. We have highly sophisticated and diverse, versatile, slim, compact, lightweight, high technology mobile phones, iPods (and now particularly the iPod touch), and the iPhone, which contains phone. All these handsets boast a breathtaking array of communication, information and entertainment applications. Ironically, however, the immediate physical storage and handling, the access of handsets, is ungainly, presenting a marked incongruity between advanced handset and its crude portable management.

This is a regulatory system—an investigation of which may be a theme of cybernetics—inasmuch as the personal management of handsets has been subject to a conceptual and structural constraint imposed on product design, manufacture and marketing, which in the Fonewear inventions is to be freed by the formulation of a new conceptual and structural paradigm. It is due to the presence in the market of a large range of detachable handset accessories and a large range of temporarily carried handset accessories, that transition to apparel-enabled continuous handset storage, access and use has not until the Fonewear inventions occurred before now.

Through the concept of proximity the Fonewear inventions reconceive the notion of handset storage, access and use through the manufactured integration of Fonewear holder into garment and pillowcase. This reconception is deepened by the garment and pillowcase providing continuous handset facility—storage, access and use may be 24 hours a day, seven days a week. Fonewear provides dynamic and assimilated systemic fluency through ease of application and the immediacy of that continuous accessibility and use. Fonewear offers enhanced alignment of human to technology through this interlocking of personal contact and public electronic applications. This conceptual and applied perspective innovatively raises personal handset management issues to a new and hitherto unachieved level that could not be anticipated by a person experienced in the handset accessories technological field because of the cultural transformation that this innovation offers—one of continuous touch access enabled by a cross-disciplinary apparel, bedware and compact technology design and production engagement—and consequent change to the consumer's immediate spatial and interactive environment.

The conceptual and multi-sector applied unity of Fonewear products also assumes an original holistic view of personal handset storage and use. Holism—the inventions considered as an operative whole are to be regarded as greater than the sum of their parts—is evident in the assimilation of garment and handset holder with pillowcase and handset holder to enable unbroken day and night handset storage, access and use. Through day and night handset storage, access and use, the Fonewear system as a whole determines in an important way how the parts behave; in the sense that a gear alone is useless but that the interconnection of a clock's gears can run a clock, the Fonewear entity has an encompassing merit greater than the discrete properties of its particular parts, a substance greater than the sum formed of the Fonewear parts.

By analogy another system of personal human activity may demonstrate Fonewear holism. The example of wearing complex multifocal spectacles may be offered. Multifocal spectacles may be worn during the day. In bright daylight these spectacles may be exchanged for the wearing of multifocal sunglasses. By analogy a Fonewear consumer may transfer a handset from a casual wear shirt to a sportswear T-shirt. When in bed spectacles are removed but positioned nearby for convenient access. With Fonewear, the handset is removed from the garment top and placed in a pillowcase holder.

In the philosophy of language, semantic holism expresses the notion that a given part of language, such as a definition, a phrase, the articulation of a complex idea, can be understood through its connection to another facet of language, or to the language as a whole. The term Fonewear can be understood through its connection to the broad facet of language that encompasses sophisticated portable technology, a part of which concerns handset storage accessories. Fonewear enlarges this aspect of semantic holism through spatially immediate, continuously available mobile device technology. In senses equally voluptuous and edgy, the Fonewear concept possesses a semantic, or linguistic, holism.

Fonewear holism may be expressed in yet another way. The Fonewear concept of spatially immediate handset storage, access and use, applied constantly throughout day and night, links the two inventions' parts and totality in a conceptual and applied relationship that in turn may be linked to larger systemic forms of stored, accessible and used communication, information and entertainment. Personal, commercial and industrial computer systems; the channelled speed and compactness of fibre-optic transmission capability; free-to-air and cable television; installations for copying and conveying communication, information and entertainment capability: at personal and impersonal levels such systems predominate in a wide range of physical locations—house, vehicle, office, Military station, space station and interstellar telescope.

The Fonewear concept is also greater than the sum of its parts as tangible inventions providing the comfort and reassurance of stable and immediate convenience, especially for the many consumers who have developed handset dependency. If Fonewear overcomes any fear of separation from a mobile device, a resultant closeness to a mobile device furnishes a fuller expression of the self through an ‘organic’ unity with communication, information and entertainment. Indeed, to the extent that Fonewear theory and practice discloses a transforming functional interaction, the Fonewear inventions more fully express the self by narrowing the distinction between self and the digital world. For Fonewear provision of enduring physical immediacy of handset storage, access and use brings the human body to closer alliance with digital technology, creating a symbiosis in which the consumer's identity changes through a consequent reshaping of popular culture. Fonewear expresses a holistic totality of psyche—prompt handset interactivity; soma—physical proximity; and of society—social media via the handset. Wear, access and use respond to and help contour a personal and collective cultural identity in which the unity of technology and human reveals a metamorphic whole greater than the sum of the parts of portable handset management.

Fonewear holism may be regarded as normative—establishing a standard through the combination of features of the inventions in the handset holder and the holder integrated to the garment and pillowcase; by the interweaving of design, psychology and biomechanics; and through the dynamic properties of day and night time storage, access and use. The Fonewear inventions are descriptively holistic through the greater benefit produced from the interaction of its construction features and its dynamically operating parts. Fonewear is an advanced personal handset management totality. Fonewear is interpretively holistic. The Fonewear inventions may be interpreted through their relationship to apparel and bedware, to other systems of human and technological interaction, and to the method of storage, access and use of personal handset accessories presently available. This invites an interpretive view of the Fonewear inventions as interpenetrating other systems—the patterns of ‘macro’, global, technological and social forms may resonate with patterns of ‘micro’, personal technological and social forms—thus enhancing both the cogency of those inventions and the improbability that a person experienced in the handset accessories technological field would anticipate or conceive such inventions.

If personal handset accessories are static and—as attachments only—disconnected, hence forming a limited, closed system, the Fonewear inventions form an open system of continuous access and ease of use, a flowing systemic connection of secure storage and access to a handset and electronic application.

The Fonewear inventions are tailored responses on one hand to rapid changes in the digital age, notably in the ready availability of communication, information and entertainment facilities on compact portable personal devices, accessible through an array of digital applications, and on the other to a lack of change evident in the apparel industry. The latter is instanced by a sameness of fashion styling and a failure to meet new developments in consumer demands and expectations. That innovation in the apparel industry is limited to the adoption of new methods in supply chain structure in neglect of the creation of new products within this single discipline—the apparel industry has not, and was never likely to, produce a multidisciplinary product, in this case apparel with affixed purpose-built handset holder. Many firms together focus on the same market segments to the exclusion of others, a sameness that reflects the single product category sameness of personal handset accessories—armbands, waist belts, pouches and bags.

By contrast, in a society marked by frequent impressive, perhaps visionary, industrial and electronic change, the Fonewear inventions lie at one confluence of that change. Fonewear is located at the junction of technological foresight and mature apparel industry myopia: Fonewear joins innovative design and applied insight to close consumer affinity with the human ‘warmth’ afforded by modern handset software capability. Continuous storage, access and use of a handset signifies not only substantive qualitative advance, it also demonstrates a shrewd market response to consumer demands and expectations. Innovative handset management expressed in the Fonewear inventions blends apparel—and bedware—with compact technology to allow consumers to manage perpetual change in society and to pattern their relationship with society.

The developers of the Fonewear inventions have understood the need of apparel producers constantly to redefine their products and the manner of production, marketing and distribution to consumers by adaptively engaging change through demonstrated conceptual and commercial flexibility and agility. Fonewear apparel creatively joins the human—psychological, aesthetic—system to the compact, portable electronic-digital technological system. The simplicity of attractive, functional wear meets the complexity of technology, a meeting of the individual need for uncomplicated convenience with the complexity of society and its advanced technologies.

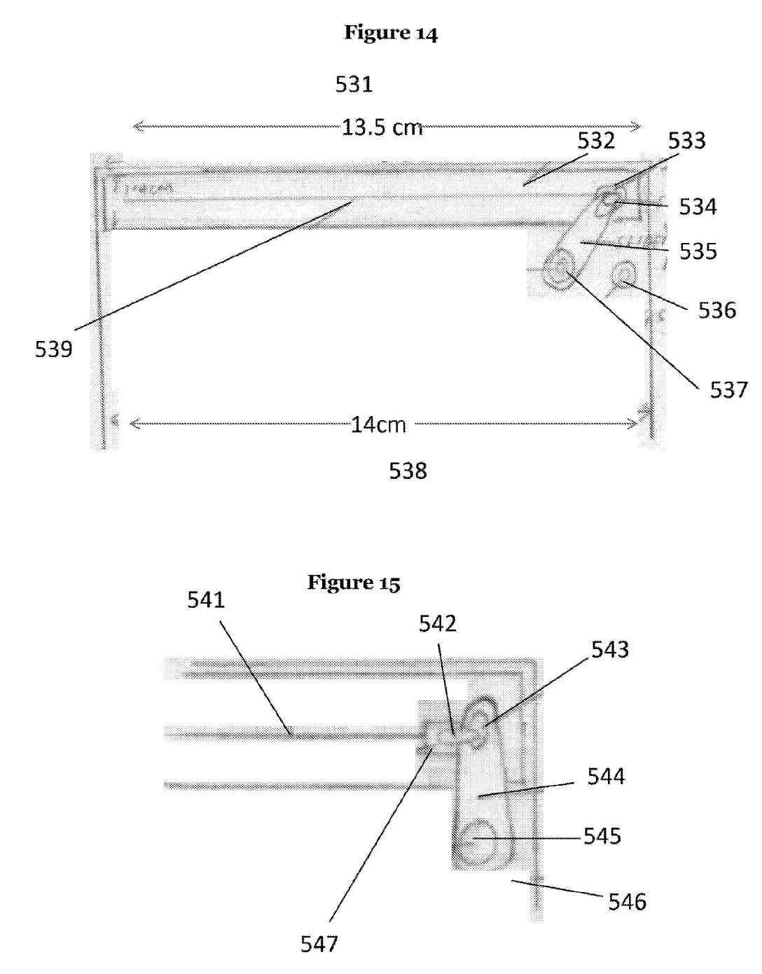

In some embodiments of the invention a closure for the pocket or handset holder is provided and in some preferred embodiments, the closure is a press stud pull tag closure as described by reference to FIGS. 14 to 17.

FIG. 14 depicts an exemplary embodiment of an opened press stud pull tag closure according to one embodiment of the invention. The handset holder opening width (551) is 13.5 cm and the total handset holder width (538) is 14 cm. This particular embodiment features a welt pocket finish (532). And the features of the press stud pull tag closure can be readily seen, namely: zip 539, zip slider 533, slider hook 534, slider toggle (which is approximately 2.5 cm in length) 535, the underside of the socket 537 and the projecting slider post 536. Zip 539 can be zipped open or shut, and socket 537 engages with slider post 536 in order to fasten the zip in a fixed position (such as in a closed position).

FIG. 15 depicts the various components of the press stud pull tag closure of some embodiments of the invention comprising a handset holder 546, in the closed position, namely: zip 541, slider hook 542, slider toggle aperture for interlocking slider hook 543, slider toggle 544, top side of socket 545 and zip slider 547.

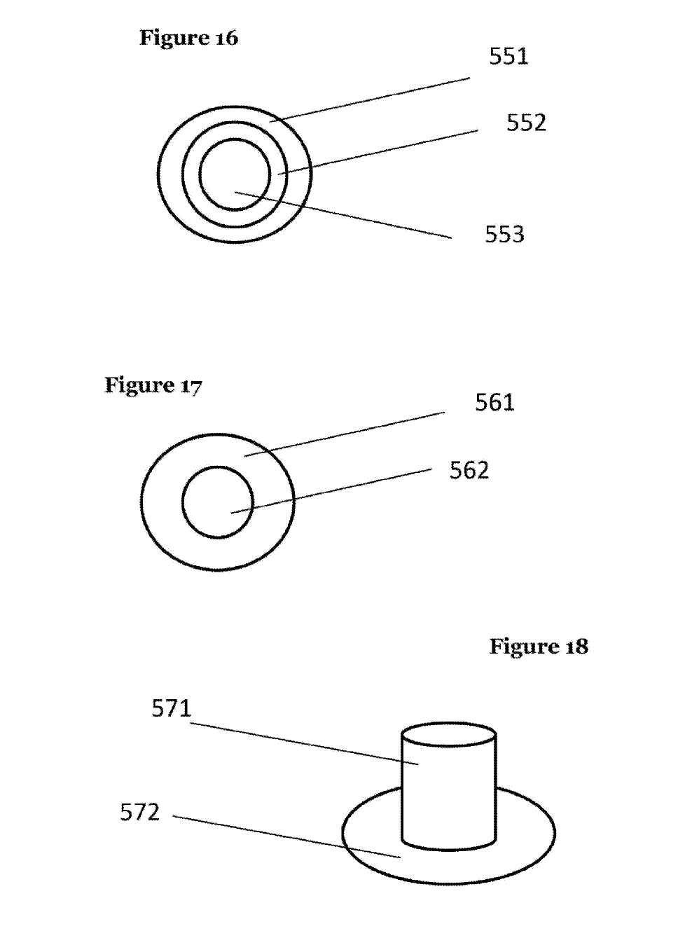

FIG. 16 depicts the socket component of the press stud fastener (which in this embodiment is 0.8 cm in diameter) and comprises: outer rim 551, inner shaft 552 and core opening to the snap clasp head of the post 553.

FIGS. 17 and 18 depict a top view and perspective view of the post component of the press stud pull tag closure (which in this embodiment is approximately 0.7 cm in diameter) and comprise: post base 561 and 562 and projecting post 571 and 572.

1. A mobile computing device holder for integral attachment to an item of apparel comprising reinforcement to reduce sag and a reversible restraint for the mobile computing device within the holder.

2. The item of apparel comprising an integral mobile computing device holder according to claim 1.

3. The item of bedware comprising an integral mobile computing device holder according to claim 1.

4. The holder according to claim 1 wherein the reinforcement comprises one or more of stitching or at least one structural material which is optionally one or more of rubber, metal, cloth, fabric, and neoprene.

5. The holder according to claim 1 comprising an at least partially radioprotective material which optionally comprises one or more of neoprene, a silver-containing material, a bismuth-containing material, a lead-containing material, a barium containing material a tungsten containing material, and Kevlar.

6. The holder according to claim 5 comprising bismuth-impregnated neoprene which is optionally of thickness in the range 0.008 to 0.100 inches.

7. The holder according to claim 1 comprising an eyelet for passage of a wire or cord such as an earphone or a headphone cord or physical connection for another other useful connecting device.

8. The item of apparel according to claim 2 wherein at least one holder is integrally located on one or more of a hip, shoulder and breast.

9. The holder according to claim 1 wherein the reversible restraint comprises one or more of a zip, a press stud, a hood closure, a hook and loop fastener, a pull tag, an over welt, and a snap closure.

10. The holder according to claim 9 further comprising a fastener to reversibly fasten the restraint in a restraining position.

11. The holder according to claim 10 wherein the fastener comprises one or more of a zip, a press stud and/or Velcro.

12. The holder according to claim 1 comprising a smaller holder to hold one or more additional items which may optionally be one or more of keys, money and credit cards.

13. The method of manufacturing an item of apparel or bedware comprising attaching a holder according to claim 1 to a pre-made article wherein the material defining an opening in the holder is at least attached around the perimeter of a corresponding opening in the item of apparel or bedware.
